(19) United States
(12) Patent Application Publication
(10) Pub. No.: US 2009/0038875 A1
(43) Pub. Date: Feb. 12, 2009

(54) OFF-ROAD ENGINE CONFIGURATION WITH NOISE REDUCTION SYSTEM

(75) Inventors: Tim W. Michalke, Thief River Falls, MN (US); Kenneth Kalsnes, Thief River Falls, MN (US)

Correspondence Address: BLACK LOWE & GRAHAM, PLLC, 701 FIFTH AVENUE, SUITE 4800, SEATTLE, WA, 98104, US

(73) Assignee: Arctic Cat, Inc., Thief River Falls, MN (US)

(21) Appl. No.: 12/235,524

(22) Filed: Sep. 22, 2008

Related U.S. Application Data
(63) Continuation-in-part of application No. 11/129,069, filed on May 12, 2005, now Pat. No. 7,438,153.

(51) Int. Cl. B60K 5/00; F02B 77/13

(52) U.S. Cl. 180/292; 181/204

(57) ABSTRACT

An off-road vehicle for traveling over land includes a frame, an engine, a transmission, and a seating arrangement. The vehicle may include side-by-side or tandem seating positions. An engine cover is configured to substantially cover the engine and operate as a sound insulator to reduce engine noise from reaching an audible location relative to the seating positions. The engine cover may take the form of a console located between the seating positions and substantially covering the engine. Further, a backing member may be coupled to the engine cover to help channel engine noise toward the rear of the vehicle. The engine cover and the backing member may include, be made from, or be lined with an acoustic material.

### PRIORITY CLAIM

This application constitutes a continuation-in-part of co-pending, commonly-owned U.S. patent application Ser. No. 11/129,069 filed May 12, 2005 entitled, “ALL-TERRAIN VEHICLE ENGINE CONFIGURATION.”

### FIELD OF THE INVENTION

This invention relates generally to engine arrangements for off-road vehicles, such as all-terrain vehicles (ATVs) multi-purpose off-road (off-highway) utility vehicles (UTVs), and recreational off-highway vehicles (RUVs) and, more specifically, to an internal combustion engine noise suppression and directing arrangement.

### BACKGROUND OF THE INVENTION

Standard ATV, UTV, and RUV engines are mounted to a frame at a position intermediate the front and rear wheels. The arrangement includes a crankcase and transmission below at least one cylinder. The transmission typically extends rearward from the crankcase. In the case of a continuously variable transmission, a drive pulley is coupled to the engine crank shaft. A belt extends rearward from the drive pulley to a driven pulley. The driven pulley is then coupled to the driveshaft or shafts through various gears or pulleys. The driveshaft, or driveshafts with a four-wheel-drive vehicle, extends to a drive or differential to propel the wheels.

This conventional arrangement generally works well, for example with a straddle mounted vehicle. However, some drawbacks with this conventional arrangement include a hot exhaust pipe; audible engine, transmission and drivetrain noise; and high engine running temperatures. The hot exhaust pipe exits the cylinder from a front side thereof and may pass by the leg of the user. Spatial packaging issues may also occur with side-by-side seating arrangements because portions of the engine may take up space needed for the driver's legs, the passenger's legs, or both.

### SUMMARY OF THE INVENTION

The present invention provides an engine and transmission arrangement for an off-road vehicle such as a RUV, UTV, or ATV that allows extra room for the driver and passenger and adds to vehicle rider comfort by reducing noise and heat levels. In one embodiment, a vehicle includes a frame, an engine, a transmission, and a driveshaft. The frame has a forward end and a rearward end. The engine is secured to the frame. The engine includes at least one cylinder and a crankcase generally below the cylinder. The transmission extends forward from the crankshaft in one preferred embodiment. The driveshaft is coupled to the transmission and to the drive or differential for driving the vehicle wheels. In addition, the vehicle includes an engine cover coupled to the frame and configured to substantially cover the cylinder and the crankcase while also configured to direct engine noise away from the engine (and operator and passenger(s)) and toward a rear portion of the vehicle. Moreover, the vehicle may include a sound shield and one or more splash panels located behind or otherwise adjacent the respective seating areas. The sound shield and the splash panels cooperate with the engine cover to direct the engine noise downward and rearward away from the seating areas, which in turn minimizes an amount of engine noise audibly detectable by the driver, passenger or both.

In one example, an off-road vehicle includes a frame having a forward end and a rearward end and a plurality of seating locations positioned generally side-by-side with respect to a transverse axis of the vehicle. The seating locations include a forward portion and a rearward portion. An engine is secured to the frame and includes a cylinder and a crankcase with a crankshaft positioned approximately beneath at least a portion of the cylinder. The cylinder includes a forward side and a rearward side. A transmission extends forward from the crankshaft and an air box is in fluid communication with the forward side of the cylinder and positioned above the engine. The engine may be substantially covered with an engine cover coupled to the frame and configured to substantially cover the cylinder, the crankcase, and the air box. The engine cover is further configured to direct engine noise from the engine toward a rear portion of the vehicle. A sound shield may be coupled to a rear portion of the engine cover and cooperates with the engine cover to direct the engine noise down and to the rear of the vehicle. The abutment between the shield and the cover is preferably sealed at the top to minimize an amount of engine noise that is audibly detectable to the driver and passenger(s).

In another example, a sound reduction system for an off-road vehicle includes an engine cover and a sound shield. The engine cover is coupled to a vehicle frame and configured to substantially cover an engine to direct engine noise away from the engine toward a rear portion of the vehicle. The sound shield is coupled to the frame and located between a seat tray and a cargo box of the vehicle. The sound shield cooperates with the seat tray to form a transversely extending passageway and further cooperates with the engine cover to minimize an amount of engine noise audibly detectable forward of the sound shield.

### BRIEF DESCRIPTION OF THE DRAWINGS

Preferred and alternative embodiments of the present invention are described in detail below with reference to the following drawings.

FIG. 1 is a side-elevational view of a vehicle according to the present invention showing selected engine components in phantom;

FIG. 2 is a side-elevational view of the left side of the engine;

FIG. 3 is a perspective view of a bench seat embodiment of the present invention; and

FIG. 4 is a side view of a straddle-mounted embodiment of the present invention.

FIG. 5A is a front, top, left side, isometric view of a seating and engine area for an off-road vehicle with an engine cover positioned over the engine according to an embodiment of the present invention;

FIG. 5B is a front, left side, isometric view of the engine cover of FIG. 5A showing a portion of the engine in phantom through the cover;

FIG. 6 is a rear, right side, isometric view of a seating and engine area for an off-road vehicle with an engine cover and sound shield(s) arranged to cover a substantial portion of the engine according to an embodiment of the present invention;

FIG. 7 is an isometric, front view of an off-road vehicle having an engine cover that cooperates with a sound panel according to an embodiment of the present invention;

FIG. 8 is a schematic diagram showing a transverse volume formed between the sound panel of FIG. 7 and seat trays according to an embodiment of the present invention; and

FIG. 9 is an isometric, rear exploded view of the sound panel of FIG. 7.

### DETAILED DESCRIPTION OF THE PREFERRED EMBODIMENTS

The present invention generally relates to an off-road vehicle such as a multi-purpose vehicle (UTV), a recreational off-road vehicle (RUV), or all-terrain vehicle (ATV) with an engine, transmission and drivetrain advantageously configured to allow for extra room for the driver and passenger and the vehicle further includes an engine cover and backing member or shield configured to reduce engine, transmission and/or drivetrain noise the may be experienced by the driver, passenger, or both. In addition, the engine cover may operate as a thermal insulator to help reduce heat transfer from the engine as experienced by the driver, passenger, or both.

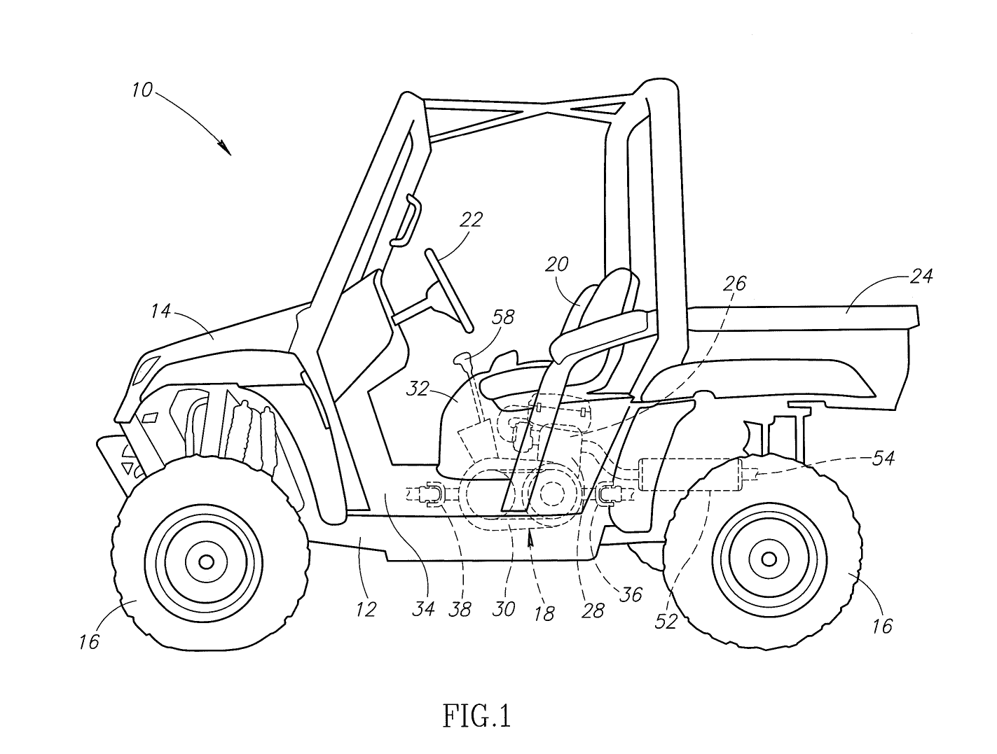

In one embodiment, the present invention provides an engine configuration for a vehicle 10 such as that illustrated in FIG. 1. Vehicle 10 includes a frame 12, a body 14, wheels 16, and an engine 18. The vehicle is arranged for side-by-side seating with individual bucket seats 20. Alternatively, a bench seat or other seating arrangement may be used. A steering wheel 22 provides a user interface for directing the movement of vehicle 10. A box such as a cargo box 24 is secured behind seats 20 for hauling miscellaneous items for work, chores, or recreation. Vehicle 20 may be two-wheel drive or four-wheel drive and may be designed for recreational or utility use. The engine configuration of the present invention is an advance to off-road vehicles providing increased operator space, reduced noise levels to the operator, cooler engine temperatures, and simplified construction.

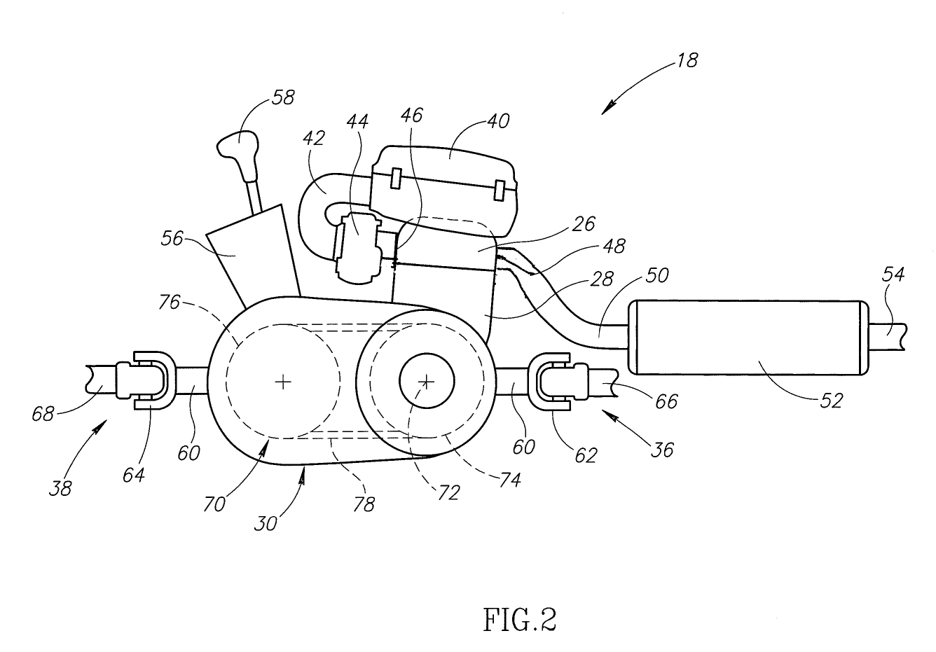

Both FIGS. 1 and 2 illustrate the basic engine configuration. The left side of engine 18 is seen in FIG. 2, removed from the vehicle frame and body for clarity of illustration. Engine 18 includes a cylinder head 26 attached atop a cylinder 28. A transmission 30 extends below and forward of cylinder 28. This arrangement contrasts with prior-art systems in which the transmission extends rearward of cylinder 28. Having the cylinder at the rearward end of the engine allows more operator room. The operator and a passenger may place their feet on a floor 34 in front of seats 20 and engine 18, as shown in FIG. 1. An engine cover 32 separates the operator from the engine components, which may be disposed between seats 20.

A rear drive line 36 extends rearwardly from engine 18 to drive the rear wheels 16 of vehicle 10. In a preferred embodiment, a front drive line 38 is also provided to drive the front wheels.

Having cylinder 28 at the rearward end of engine 18 also allows for a simplified arrangement of the air-intake and exhaust systems. Thus, an air box/air cleaner 40 is positioned above engine 18 with an intake hose 42 leading to a carburetor 44 attached to an intake port 46 on the forward side of cylinder 28 above transmission 30. In any embodiment described herein the “carburetor” may be replaced with a throttle body for fuel injection. The space in front of cylinder 28 and above transmission 30 provides a convenient location for positioning of these components and also allows for cooler air to be fed into cylinder 28 for cooler engine operating temperatures. Note that alternatively, other fuel and air flow mechanisms may be used, such as fuel injection.

Also convenient in this engine arrangement is exhaust port 48 situated on the rearward side of head 26. An exhaust pipe 50 is secured to exhaust port 48 to channel exhaust gases rearward of head 26. Exhaust pipe 50 is connected to a muffler 52, which is in turn connected to a tailpipe 54. Thus, the path of hot gases extends directly rearward from head 26. This results in less chance of hot engine components being in the vicinity of the operator or passengers of vehicle 10. Furthermore, the noise produced by the exhaust system is shifted rearward such that the levels to the operator and passenger are reduced. Simpler and fewer parts are also required for the exhaust system that does not need to curve around the front of the cylinder before sending exhaust gases to the tailpipe.

A simplified shift mechanism 56 is also secured to the front of the transmission 30. Positioning in this manner allows the shift mechanism to be conveniently located adjacent the seat of the operator of vehicle 10 without additional linkages. The shift mechanism 56 includes a shift lever 58 extending outwardly for operator control. In the preferred embodiment of the present invention, shift mechanism 56 is employed to select between forward (high and low range), neutral, and reverse operation with an automatic transmission system described below.

The engine drive mechanism includes an engine drive shaft 60 driven by transmission 30 and extending fore and aft of transmission 30. Drive shaft 60 includes a rear U-joint 62 and a front U-joint 64 inter-connecting rear and front drive shafts 66 and 68. Drive shafts 66 and 68 extend rearwardly and forwardly, respectively, to forward and rearward drives (not shown) to propel wheels 16. Alternatively, a rearward-drive-only system may be employed or a front-drive-only system may be employed.

The engine preferably includes a continuously variable transmission 70. Other manual or automatic transmissions may alternatively be employed. Continuously variable transmission 70 is secured to a crank shaft 72 of engine 18. A drive pulley 74 is secured to crank shaft 72 with a driven pulley 76 positioned forwardly therefrom. A belt 78 couples the two pulleys, which include spring-loaded sheaves in a conventional arrangement to create a continuously variable transmission. A gear mechanism couples the driven pulley to engine drive shaft 60.

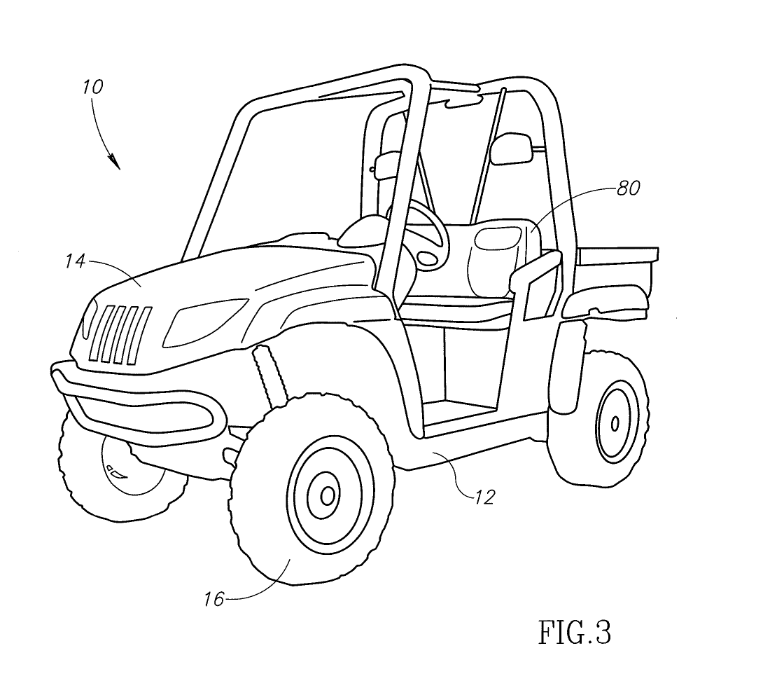

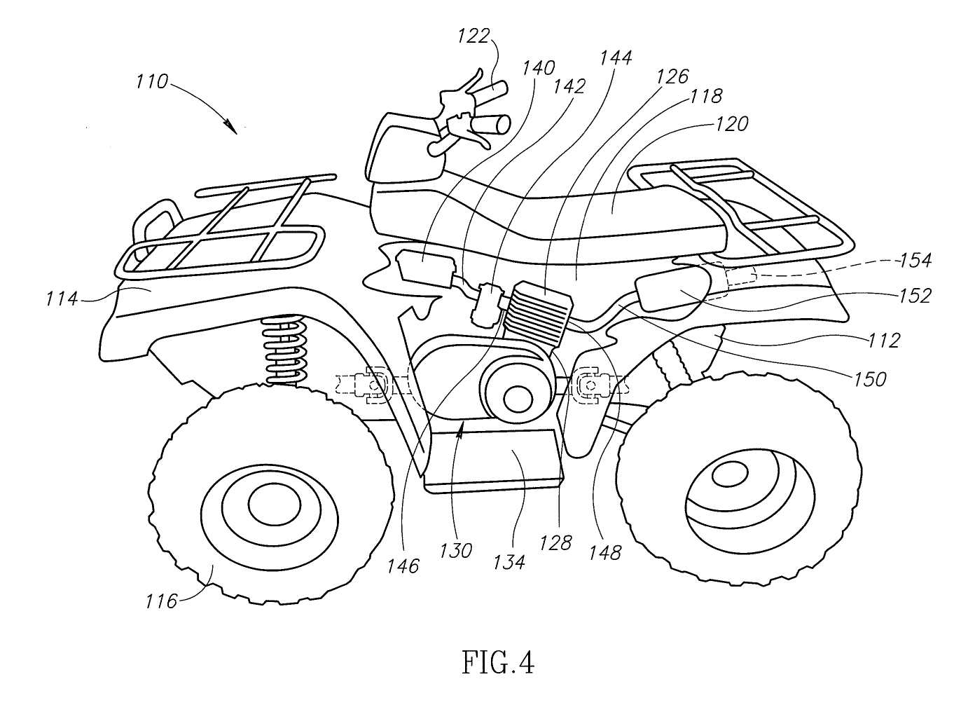

This basic engine configuration may be used in various embodiments of utility vehicles or ATVs. For example, FIG. 3 illustrates a bench-seat arrangement of a utility vehicle with a side-by-side seating 80. FIG. 4 illustrates an ATV 110 with a straddle-mounted seat arrangement employing the engine configuration of the present invention. Such an ATV may be configured for one or more passengers seated behind the vehicle operator.

More specifically, as illustrated in FIG. 4, ATV 110 includes a frame 112 with a body 114 secured thereto. Wheels 116 are also coupled to the frame through a suspension system. Engine 118 is similar to that described above in connection with FIG. 2 and is situated such that head and cylinder 126 is positioned at the rearward side of transmission 130. A seat 120, positioned above engine 118 and handlebars 122, allows the operator to control the driving direction of ATV 110.

As with the engine illustrated in FIG. 2, note that a crank case 128 is positioned below head and cylinder 126 with transmission 130 extending forwardly therefrom. Footwells 134 are positioned on either side of engine 118.

The air box/air cleaner 140 has an intake hose 142 connected to a carburetor 144. Cleaner 140 is positioned forward of carburetor 144, above the forwardly extending portion of transmission 130. The carburetor is connected to an intake port 146 on the forward side of head and cylinder 126 such that cool air flows into engine 118 for cooler engine operating temperatures than with a conventional arrangement.

Further note that an exhaust port 148 is positioned on the rearward side of head and cylinder 126 with an exhaust pipe 150 extending to muffler 152, all rearward of head and cylinder 126. A tailpipe 154 allows gases to be expelled at the rearward end of ATV 110.

The system for ATV 110 works best with an automatic transmission, such as a continuously variable transmission described above. However, a manual or other transmission system may alternatively be used. Extending the exhaust pipe directly rearward of head and cylinder 126 increases rider safety since the hot pipe does not extend pass the rider's leg.

The following description generally relates to aspects of the present invention for minimizing noise as heard by a driver, a passenger or both of an off-road vehicle. The noise reducing components may be arranged to cooperate with a conventional engine configuration or an engine configuration such as the one described above with respect to FIGS. 1-4. In one example, the noise reducing components operating together may reduce a variety of vehicle noises that may otherwise be audible by the driver, the passenger or both. For example, the noise reducing components may reduce noise from the engine, the transmission, and the drivetrain.

Further, the source of noise may have a higher frequency content of approximately 600 Hertz (Hz) and above or a lower frequency content (e.g., below 600 Hz). By way of example, the higher frequency noise may be produced from gear meshing, clutch actuation, exhaust, intake, drive shaft movement, etc.; whereas the lower frequency noise may be produced from operation of the engine. In one example achieved during testing, the various noise levels perceptible by the driver, the passenger or both were reduced by about 10.7 decibels (dB; as measured using the A scale in dBA) during an engine idling condition, by about 2.5 dBA when the vehicle was travelling at approximately 10 miles per hour (mph), and by about 5.4 dBA when the vehicle was travelling at about 40 mph.

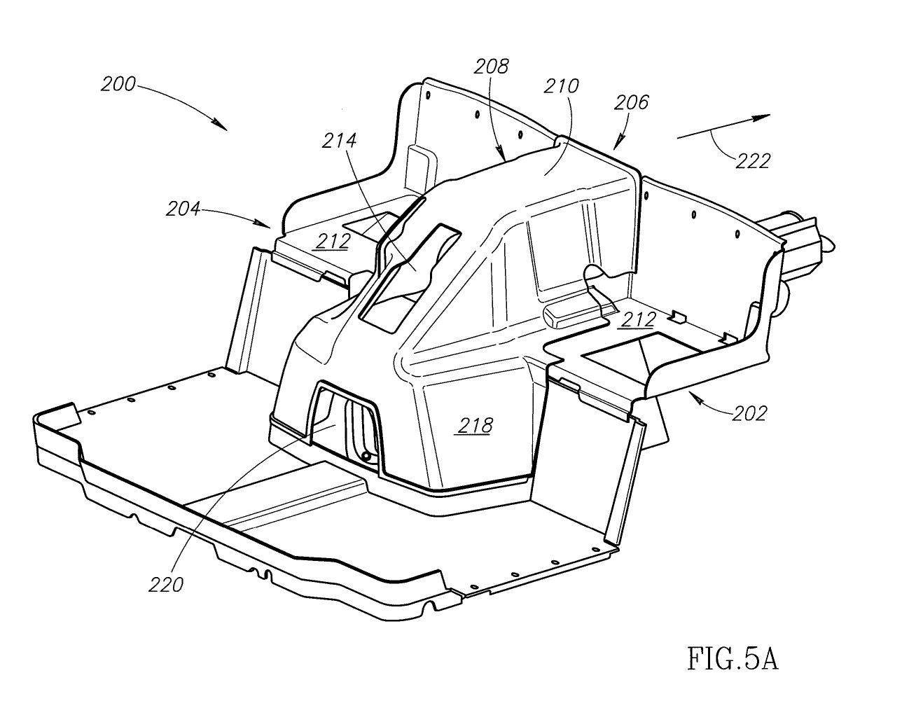

FIGS. 5A and 5B show a portion of an off-road vehicle 200 having a left seating position 202 and a right seating position 204 (e.g., side-by-side) arranged with a sound packaging system 206, which may take the form of an engine cover 208 located between the seating positions 202, 204. The engine cover 208 includes an upper portion 210 extending above a seating surface 212. The upper portion 210 may be smoothly contoured and operate as an arm rest. In addition, the upper portion 210 may include an opening 214 for inclusion of a shift lever and/or for permitting access to the engine 216 (FIG. 5B). In addition, the engine cover 208 includes a lower portion 218, which may also include an opening 220 for a hose or other component and/or for permitting access to another region of the engine 216. Preferably, the engine cover 208 is formed as a unitary or single piece component and is attachable to the frame (not shown) of the vehicle 200. The engine cover 208 is sized to substantially encapsulate the engine 216.

The engine cover 208 may be made from an acoustic material or may be formed from another type of material (e.g., plastic) and coupled to an acoustic liner. In one embodiment, the acoustic material or liner takes the form of acoustic foam arranged to direct the sound flow toward the rear 222 of the vehicle 200. The arrangement may also reflect sound energy back toward the engine 216. Further, the acoustic foam may absorb at least some of the higher frequency sound energy.

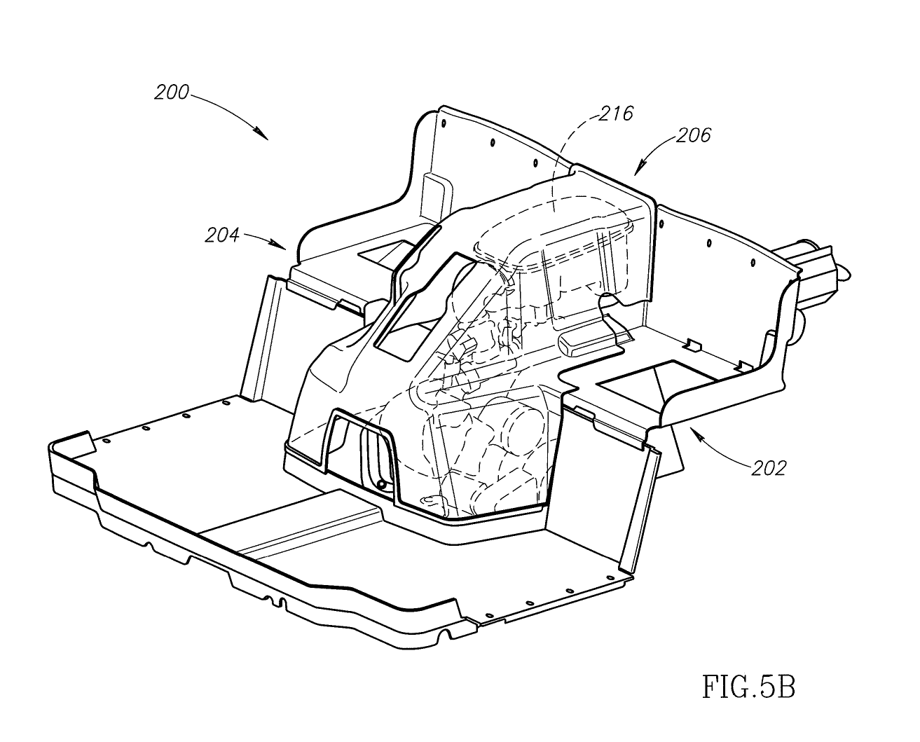

FIG. 6 shows the vehicle 200 further having a sound shield 224 located aft of the seating positions 202, 204. The sound shield 224 may be comprised of multiple panels or be a monolithic structure extending transversely from one side of the vehicle to the other side proximate an aft portion of the engine cover 208. Alternatively or additionally, left-side and right-side splash panels 225 may be coupled to the vehicle 200. The splash panels 225 extend around the wheels (not shown) of the vehicle 200 and downward from the engine 216 and may even extend around at least a portion of a transmission (not shown), a drivetrain (not shown), and a portion of a cargo box support frame 228. The sound shield 224 and the splash panel 225 may be made out of the same or similar material as the engine cover 208. And like the engine cover 208, both the sound shield 224 and the splash panel 225 may be lined with an acoustic material arranged to direct the sound flow toward the rear 222 of the vehicle 200.

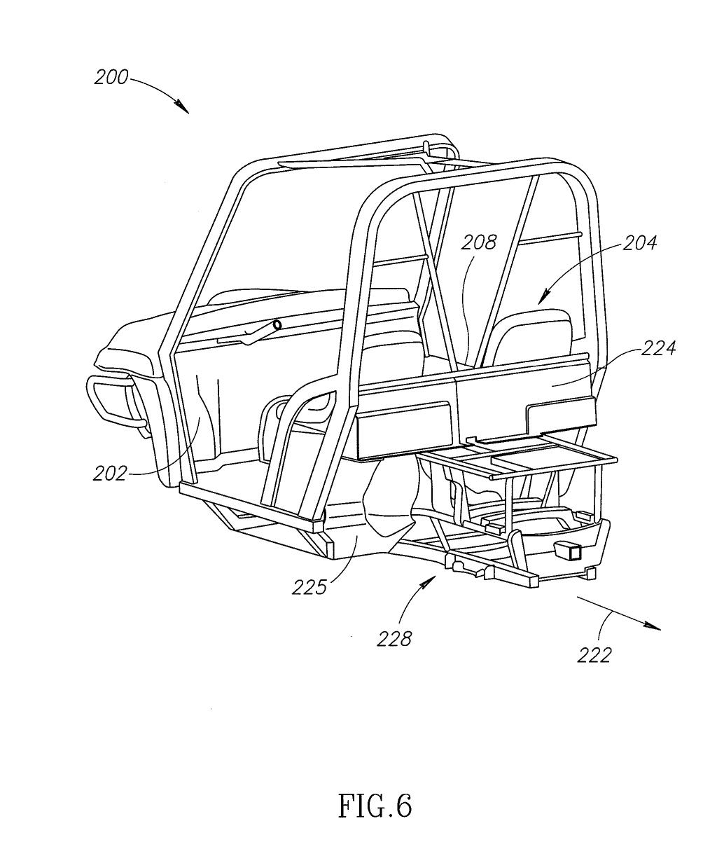

FIG. 7 shows a portion of an off-road vehicle 300 having a main vehicle body 302 and a cargo region 304 located behind the main vehicle body 302. The main vehicle body 302 includes an engine substantially enclosed by an engine cover 308, a driver's seat region 310, and a passenger's seat region 312. To augment the noise reduction achieved by the engine cover 308 as discussed above, a sound shield 314 is located between the cargo region 304 and the seat regions 310, 312. The sound shield 314 is preferably molded from plastic. In alternate embodiments the sound shield is stamped. It may also be constructed of different materials such as aluminum.

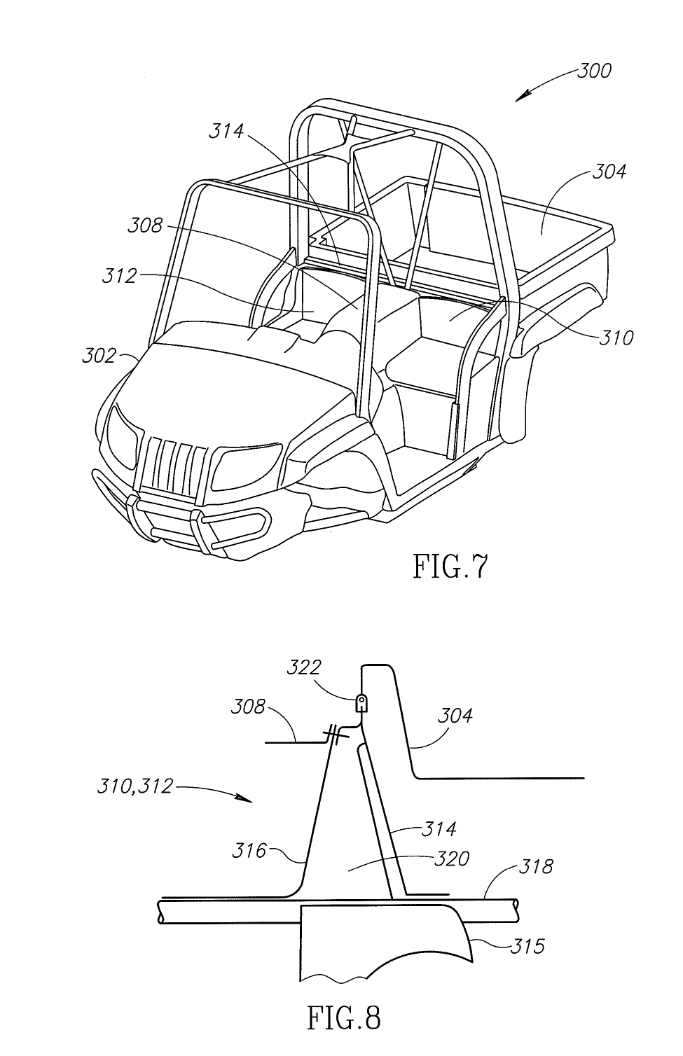

FIG. 8 schematically shows the sound shield 314 located approximately between the seat regions 310, 312 and the cargo region 304. The seat regions 310, 312 include seat trays 316, which are coupled to a frame 318 and positioned adjacent the engine cover 308. In one embodiment, the sound shield 314 and a splash panel 315 cooperate with the engine cover 308 to provide an acoustic pathway for directing engine and other mechanical noise downward and rearward with respect to the seat regions 310, 312. In addition, the pathway may operate to direct hot air from the engine while providing a sufficient amount of space for an engine inlet (not shown). In addition, the sound shield 314 may include a seal 322 and thus be sealed relative to the cargo region 304 (e.g., cargo box).

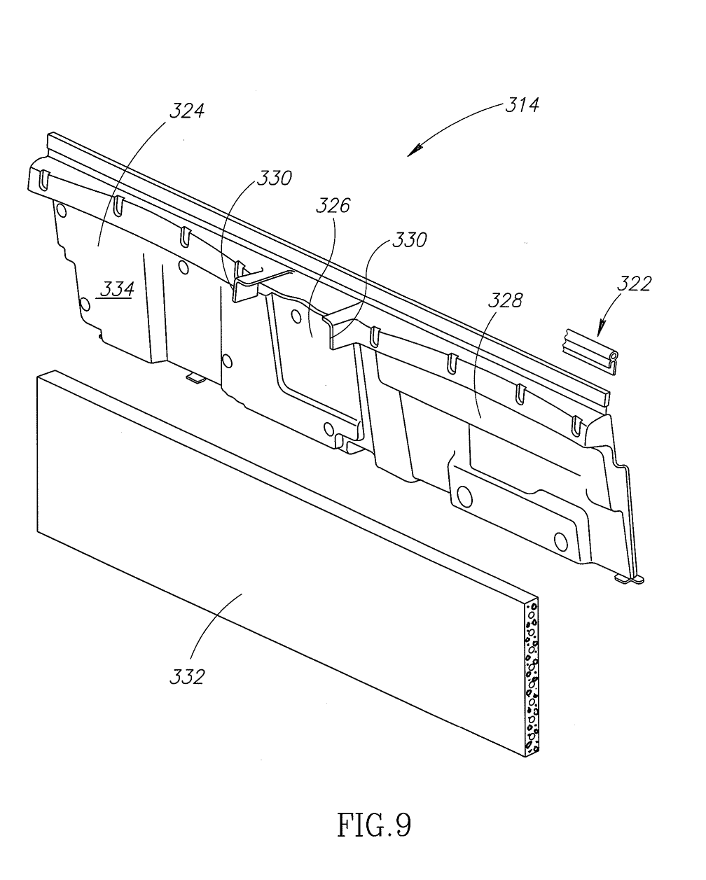

FIG. 9 shows an embodiment of the sound shield 314 having a driver's side portion 328, a center portion 326 and a passenger's side portion 324. The sound shield 314 may take the form of a molded, plastic panel; whereas the seal 322 may take the form of an elastomeric or foam strip. Further, the sound shield 314 may include extensions 330 that are received by the engine cover 308 and may be bonded or otherwise fastened thereto. The seal 322 is coupled or supported on a top portion of the sound shield 314. In one embodiment, the sound shield 314 may include a layer of acoustical foam 332 coupled to one or both sides of the sound shield 314. In one embodiment the acoustical foam 332 includes a sealing skin to make it water resistant. The acoustical foam 332 may be fastened, bonded, or otherwise attached to the sound shield 314. If fastened, the acoustical foam 332 may be coupled to the sound shield 314 using molded bosses or clips. Preferable, the foam 332 may be located between the seat regions 310, 312 (FIG. 8) and a front surface 334 of the sound shield 314.

While the preferred embodiments of the invention have been illustrated and described, as noted above, many changes can be made without departing from the spirit and scope of the invention. Accordingly, the scope of the invention is not limited by the disclosure of the preferred embodiments. Instead, the invention should be determined entirely by reference to the claims that follow.

The embodiments of the invention in which an exclusive property or privilege is claimed are defined as follows:

1. An off-road vehicle comprising:
a frame having a forward end and a rearward end;
a plurality of seating locations positioned generally side-by-side with respect to a minor axis of the vehicle, the seating locations having a forward portion and a rearward portion;
an engine secured to the frame, the engine having a cylinder and a crankcase positioned approximately beneath at least a portion of the cylinder, the cylinder including a forward side and a rearward side;
a transmission extending forward from the crankcase;
an air box in fluid communication with the forward side of the head and cylinder and positioned directly above the head and cylinder;
an engine cover coupled to the frame and configured to substantially cover the cylinder, the crankcase, the engine cover further configured to direct engine noise from the engine toward a rear portion of the vehicle; and
a sound shield positioned behind the seating locations and cooperating with the engine cover to direct the engine noise rearward and downward away from the seating locations to minimize an amount of engine noise audibly detectable near the seating locations.

2. The vehicle of claim 1, wherein the engine cover includes an acoustic material attached to an inner surface thereof to help minimize the amount of engine noise audibly detectable near the plurality of seating locations.

3. The vehicle of claim 1, wherein the sound shield includes an acoustic material attached to a forward surface thereof to help minimize the amount of engine noise audibly detectable near the plurality of seating locations.

4. The vehicle of claim 1, further comprising:
a drive train cover configured to cover at least a portion of the drive train extending from a rear portion of the engine, a front portion of the drive train located proximate the backing member.

5. The vehicle of claim 4, wherein the drive train cover includes an acoustic material attached to an inner surface thereof to help minimize an amount of drive train noise audibly detectable near the plurality of seating locations.

6. The vehicle of claim 1, wherein the vehicle includes a longitudinal axis directed substantially fore-aft and the minor axis is substantially normal to the longitudinal axis.

7. The vehicle of claim 1, further comprising:
a splash panel positioned adjacent at least one of the seating locations.

8. The vehicle of claim 7, wherein the engine cover, sound shield, and the splash panel are positioned closely adjacent one another to absorb and direct sound rearward and downward relative to the seating locations.

9. The vehicle of claim 1, wherein the engine cover is immediately adjacent the sound shield.

10. The vehicle of claim 1, wherein the engine is positioned forward of the rearward portion of the seating locations.

11. An off-road vehicle comprising:
a frame having a forward end and a rearward end;
left and right seating positions each having a forward portion and a rearward portion located adjacent to a cargo region;
an engine secured to the frame;
a drivetrain assembly extending from the engine;
an engine cover coupled to the frame and configured to substantially cover the engine and direct engine noise away from the engine toward a rear portion of the vehicle; and
a sound shield coupled to the frame and located between the seating positions and the cargo region, the sound shield cooperating with seat trays to form a transversely extending passageway and configured to minimize an amount of engine noise audibly detectable near at least one of either the left or right seating position.

12. The vehicle of claim 11, wherein the engine is positioned forward of the rearward portion of the left and right seating positions and a substantial portion of the engine is located between the left and right seating positions.

13. The vehicle of claim 11, wherein the engine cover includes an acoustic material attached to an inner surface thereof to help minimize the amount of engine noise audibly detectable near at least one of either the left or right seating position.

14. The vehicle of claim 11, wherein the sound shield is a panel coupled to an acoustic material.

15. The vehicle of claim 11, further comprising: a seal located between a top portion of the sound shield and the cargo region.

16. A sound reduction system for an off-road vehicle, the system comprising:
an engine cover coupled to a vehicle frame and configured to substantially cover an engine to direct engine noise away from the engine toward a rear portion of the vehicle; and
a sound shield coupled to the frame and located between a seat tray and a cargo area of the vehicle, the sound shield cooperating with the seat tray to form a downward and rearward extending passageway, the sound shield further cooperating with the engine cover to minimize an amount of engine noise audibly detectable forward of the sound shield.

17. The vehicle of claim 16, wherein the engine cover includes an acoustic material attached to an inner surface thereof to help minimize the amount of engine noise audibly detectable forward of the sound panel.

18. The vehicle of claim 16, wherein the sound panel is a molded panel made with an acoustic material.

19. The vehicle of claim 16, further comprising:
a seal located between a top portion of the sound panel and the cargo area.

20. A method of reducing noise experienced by users of an off-road vehicle, the method comprising:
covering a substantial portion of an engine with an engine cover, the engine cover configured to direct engine noise away from the engine and toward a rear portion of the vehicle; and
positioning a sound shield aft of a seating position within the vehicle, the sound shield cooperating with a seat tray to form a rear close-off of the engine cover, the sound shield further cooperating with the engine cover to minimize an amount of engine noise audibly detectable forward of the sound shield.

21. The method of claim 20 wherein positioning the sound shield includes coupling the sound shield to the engine cover.

22. The method of claim 20, further comprising:
sealing the sound shield to a cargo box of the vehicle.
